(19) United States
(12) Patent Application Publication
(10) Pub. No.: US 2013/0265901 A1
(43) Pub. Date: Oct. 10, 2013

(54) Coordinating Communications in radio Service Areas

(71) Applicants: Klaus Ingemann Pedersen, Aalborg (DK); Frederiksen Frank, Klarup (DK)

(72) Inventors: Klaus Ingemann Pedersen, Aalborg (DK); Frederiksen Frank, Klarup (DK)

(73) Assignee: Nokia Siemens Networks Oy, Espoo (FI)

(21) Appl. No.: 13/877,926

(22) PCT Filed: Oct. 6, 2010
(86) PCT No.: PCT/EP2010/064935

§ 371 Date: Jun. 24, 2013

(51) Int. Cl. H04W 64/00

(52) U.S. Cl. CPC H04W 64/00
USPC 370/252

(57) ABSTRACT

Methods and apparatuses for coordinating muting in a system including radio service areas of a first type and of a second type are disclosed. In a method a node providing a radio service area of the first type detects a first radio service area of the second type and determines information suitable for determining the location of the node. Said information for identifying the first radio service area and said information suitable for determining the location of the node are communicated to a controls apparatus. Upon receipt of said information for identifying and information suitable for determining the location of the node the control apparatus can coordinate muting based on the received information.

This disclosure relates to coordination of communications in a communication system comprising different radio service areas, and in particular coordinating muting in said different radio service areas.

A communication system can be seen as a facility that enables communication sessions between two or more entities such as fixed or mobile communication devices, base stations, servers and/or other communication nodes. A communication system and compatible communicating entities typically operate in accordance with a given standard or specification which sets out what the various entities associated with the system are permitted to do and how that should be achieved. For example, the standards, specifications and related protocols can define the manner how communication devices can access the communication system and how various aspects of communication shall be implemented between communicating devices. A communication can be carried on wired or wireless carriers. In a wireless communication system at least a part of the communication between at least two stations occurs over a wireless link.

Examples of wireless systems include public land mobile networks (PLMN) such as cellular networks, satellite based communication systems and different wireless local networks, for example wireless local area networks (WLAN). A wireless system can be divided into cells, and hence these are often referred to as cellular systems. A cell is provided by a base station. Cells can have different shapes and sizes. A cell can also be divided into sectors. Regardless of the shape and size of the cell providing access for a user and whether the access is provided via a sector of a cell or a cell, such area can be called radio service area or access area. Neighbouring radio service areas typically overlap, and thus a communication device in an area can often listen to more than one base station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station of an access network and/or another user equipment. The communication device may access a carrier provided by a station, for example a base station, and transmit and/or receive communications on the carrier.

An example of communication systems attempting to satisfy the increased demands for capacity is an architecture that is being standardized by the 3rd Generation Partnership Project (3GPP). This system is often referred to as the long-term evolution (LTE) of the Universal Mobile Telecommunications System (UMTS) radio-access technology. A further development of the LTE is often referred to as LTE-Advanced. The various development stages of the 3GPP LTE specifications are referred to as releases.

A communication system can be provided by means of different types of radio service areas. For example, in LTE-Advanced the network nodes can be wide area network nodes such as a macro eNode B (eNB) which may, for example, provide coverage for an entire cell or similar radio service area. Network nodes can also be small or local radio service area network nodes, for example Home eNBs (HeNB) or pico eNodeBs (pico-eNB). The smaller radio service areas can be located wholly or partially within the larger radio service area. A local service area may also be located within, and thus listen to, more than one larger radio service area. The nodes of the smaller radio service areas such as the HeNBs may be configured to support local offload. The local nodes may support any user equipment(s) belonging to a closed subscriber group (CSG) or an open subscriber group (OSG). The local nodes can also, for example, be configured to extend the range of a cell. In some instances a combination of wide area network nodes and small area network nodes can be deployed using the same frequency carriers (e.g. co-channel deployment).

Interference coordination between different radio service areas can be provided. For example, an aspect of LTE-Advanced is that time domain multiplexing (TDM) enhanced inter-cell interference coordination (eICIC) can be applied to network nodes to reduce interference between the network nodes. In some scenarios eICIC can be used for co-channel deployment of macro-eNBs and CSG HeNBs and/or co-channel deployment of macro-eNBs and pico-eNBs. A so-called muting pattern enforced at the HeNBs may be used for the coordination. For example, the coordination can be used to maintain performance, or at least ensure functioning, of users connected to the macro-eNB. Optimal configuration and/or coordination of the patterns may be particularly challenging in case of macro-eNB and CSG-Home-eNBs being deployed on same frequency carriers.

It is noted that the above discussed issues are not limited to any particular communication environment, but may occur in any appropriate communication system comprising a plurality of radio service areas where muting of data transmissions may be provided.

Embodiments of the invention aim to address one or several of the above issues.

In accordance with an embodiment there is provided a method for coordinating muting in a system comprising radio service areas of a first type and of a second type, the method comprising: detecting, by a node providing a radio service area of the first type, a first radio service area of the second type based on a first criteria; determining information suitable for determining the location of the node; and communicating information for identifying the first radio service area and said information suitable for determining the location of the node.

In accordance with an embodiment there is provided a method for controlling muting in a system comprising radio service areas of a first type and of a second type, the method comprising: receiving from a node providing a radio service area of the first type information for identifying a first radio service area of the second type; receiving information suitable for determining the location of the node; and coordinating muting based on the received information.

In accordance with an embodiment there is provided an apparatus for use in coordinating muting in a system comprising radio service areas of a first type and of a second type, the apparatus comprising at least one processor, and at least one memory including computer program code, wherein the at least one memory and the computer program code are configured, with the at least one processor, to detect a first radio service area of the second type based on a first criteria at a node providing a radio service area of the first type, to determine information suitable for determining the location of the node, and to cause communication of information for identifying the first radio service area and said information suitable for determining the location of the node.

In accordance with an embodiment there is provided an apparatus for controlling muting in a system comprising radio service areas of a first type and of a second type, the apparatus comprising at least one processor, and at least one memory including computer program code, wherein the at least one memory and the computer program code are configured, with the at least one processor, to process information for information identifying a first radio service area of the second type, the information being received from a node providing a radio service area of the first type, to process information suitable for determining the location of the node, and to coordinate muting based on the information.

In accordance with a more specific embodiment at least one second radio service area of the second type is detected based on a second criteria, and information for identifying the at least one second radio service area of the second type is communicated from the node to a control apparatus. In accordance with an embodiment the first criteria is satisfied by a radio service area of the second type that is determined to offer the most appropriate radio coverage or where the node is located. The first criteria can be satisfied by a radio service area of the second type determined to have the strongest power. In accordance with an embodiment the second criteria satisfied by a radio service area of the second type that is determined to be within a predefined range, for example to have a power that is within a predefined range from the power of the first radio service area of the second type.

The node may be assigned with an indication of closeness to a border between the first and the at least one second radio service areas of the second type.

Information suitable for determining the location of the node may comprise information about at least one of received power of a reference signal, path loss, channel quality, link quality and an estimated location of the node.

Information relating to at least one second radio service area of the first type may be determined and communicated.

A plurality of nodes for providing a radio service area of the first type within the first radio service area of the second type may monitor for radio service areas of the first and/or second type and communicate information regarding the identity and location of detected radio service areas.

The coordination may comprise controlling the number of muted subframes.

Muting patterns between different radio service areas may be shifted.

Number and/or density of active nodes providing radio service areas of the first type may be determined. Also, number of nodes providing radio service areas of the first type that located at cell border areas and/or power distribution in the first radio service area of the second type may be determined.

A computer program comprising program code means adapted to perform the method may also be provided.

Various other aspects and further embodiments are also described in the following detailed description and in the attached claims.

The invention will now be described in further detail, by way of example only, with reference to the following examples and accompanying drawings, in which:

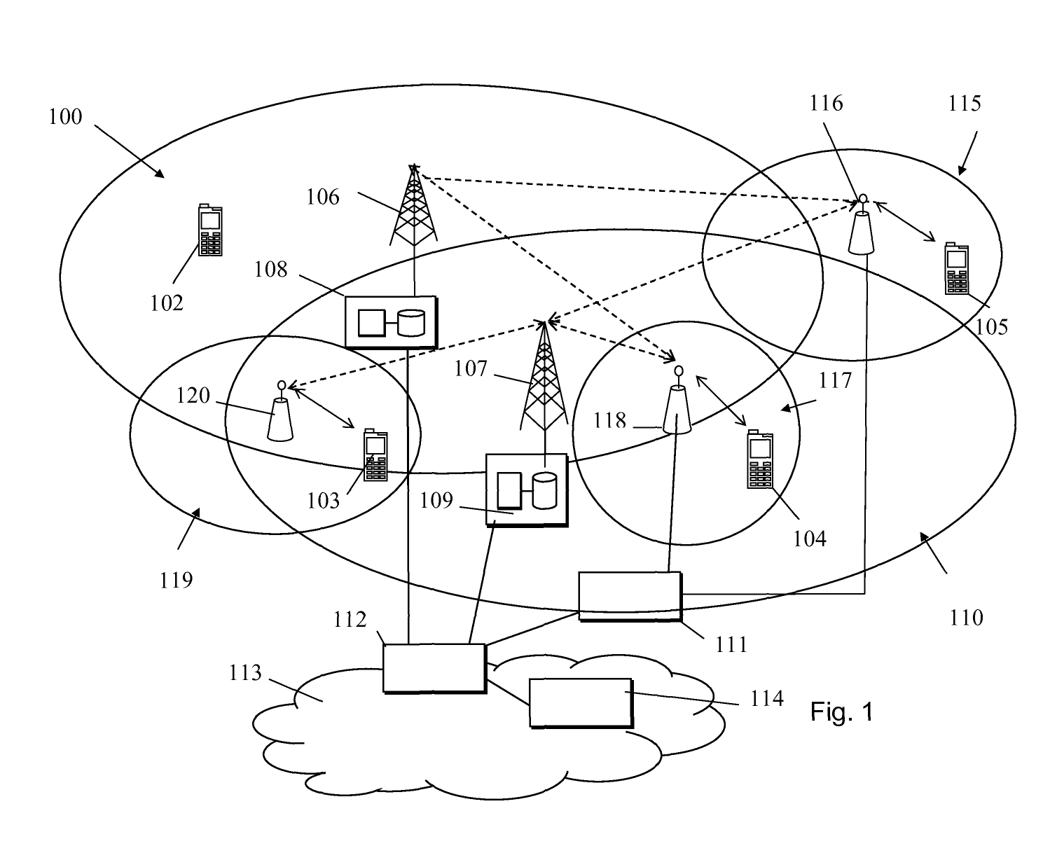

FIG. 1 shows a schematic diagram of a network according to some embodiments;

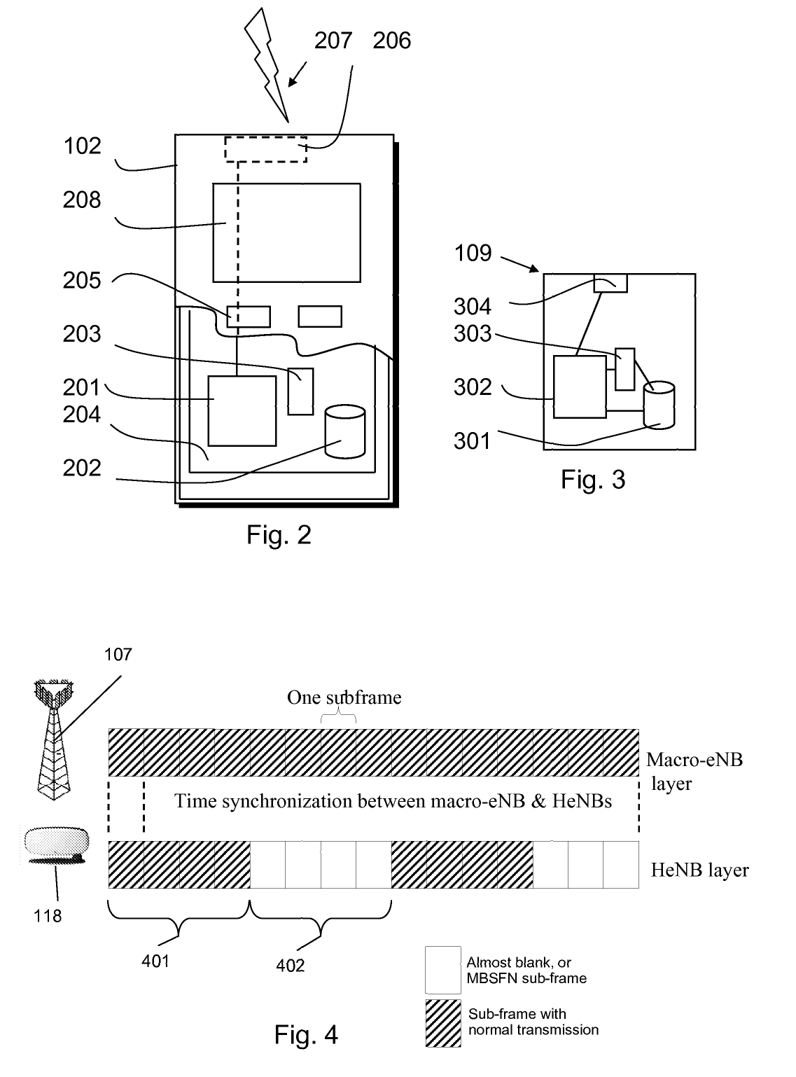

FIG. 2 shows a schematic diagram of a mobile communication device according to some embodiments;

FIG. 3 shows a schematic diagram of a control apparatus according to some embodiments;

FIG. 4 shows a representation of downlink transmission in sub-frames according to some embodiments; and

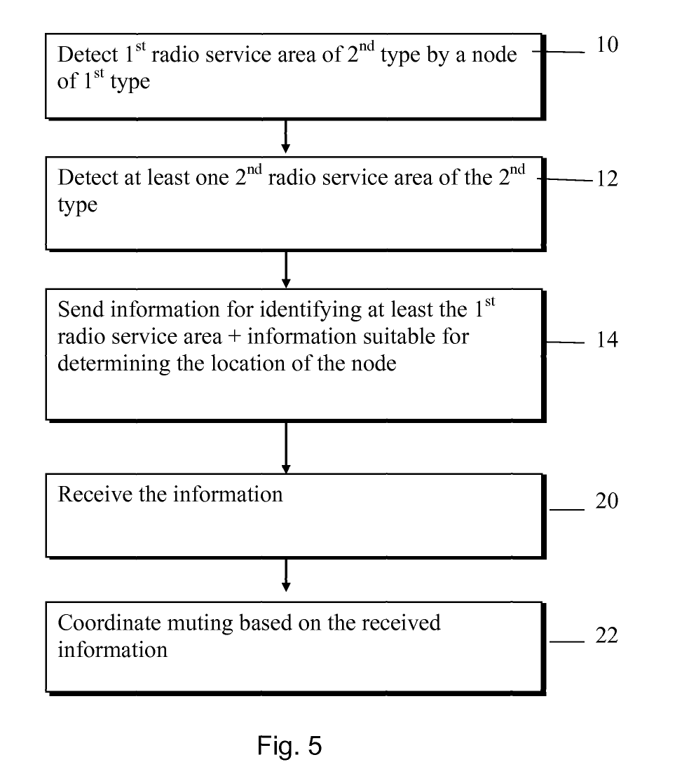

FIG. 5 shows a flow diagram illustrating a method according to some embodiments.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A mobile communication device or user equipment 102, 103, 104, 105 is typically provided wireless access via at least one base station or similar wireless transmitter and/or receiver node of an access system. In FIG. 1 two neighbouring and overlapping access systems or radio service areas of a first type 100 and 110 and three local or smaller radio service areas of a second type 115, 117 and 119 are shown. The radio service areas are provided by base stations 106, 107, 116, 118 and 120.

It is noted that instead of the shown number of access systems, any number of access systems can be provided in a communication system. An access system can be provided by a cell of a cellular system or another system providing radio access for a communication device. A base station site can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas. Each mobile communication device and base station may have one or more radio channels open at the same time and may send signals to and/or receive signals from more than one source.

Base stations are typically controlled by at least one appropriate controller apparatus so as to enable operation thereof and management of mobile communication devices in communication with the base stations. In FIG. 1 control apparatus 108 and 109 is shown to control the respective base stations 106 and 107. The control apparatus of the smaller service areas is not shown for clarity. The control apparatus of a base station can be interconnected with other control entities. The control apparatus is typically provided with memory capacity and at least one data processor. The control apparatus and functions may be distributed between a plurality of control units.

The cell borders or edges are schematically shown for illustration purposes only in FIG. 1. It shall be understood that the sizes and shapes of radio service areas may vary considerably from the shapes of FIG. 1.

The communication devices 102, 103, 104, 105 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate LTE access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

FIG. 1 depicts two wide radio service area base stations 106 and 107, which can be macro-eNBs. A macro-eNB transmits and receives data over the entire coverage of the cell it provides. FIG. 1 also shows three smaller base stations or access points which can be provided by Home eNBs 116, 118 and 120. The coverage of these base stations may generally be smaller than the coverage of the wide area base stations. The coverage provided by the smaller nodes 116, 118 and 120 can overlap with the coverage provided by one or more of the macro-eNBs 106 and 107. Although not shown, the local radio service areas can also overlap with each other. Thus signals transmitted in an area can interfere with communications in another area. A home-eNB (HeNB) can provide local offload of capacity to mobile communication devices. A HeNB can provide services to only mobile communication devices which are members of a closed subscriber group (CSG). Alternatively a HeNB can provide services to any mobile communication devices which are within the local area of the HeNB.

In FIG. 1 the base stations 106 and 107 can be connected to a wider communications network 113 via gateway 112. A gateway function may be provided to connect to another network. The smaller base stations 116, 118 and 120 can also be connected to the network 113 by a separate gateway function. For example, the HeNB 116 and 118 can be connected via a HeNB gateway 111. The base stations 106, 107, 116, 118 and 120 can also be connected to each other by a communication link for sending and receiving data, this being shown by the dashed lines. The communication link can be any suitable means for sending and receiving data between the base stations. In certain embodiments the communication link can be an X2 link.

The mobile communication devices will now be described in more detail in reference to FIG. 2. FIG. 2 shows a schematic, partially sectioned view of a communication device 102 that a user can use for communication. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information. The mobile device 102 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided, for example at base stations and mobile stations, and the transceiver apparatus 206 of FIG. 2 can provide a plurality of antenna ports. More data can be received and/or sent where there are more antennae elements. A station may comprise an array of multiple antennae. Signalling and muting patterns can be associated with Tx antenna numbers or port numbers of MIMO arrangements.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus 109 for a communication system, for example to be coupled to and/or for controlling a station of an access system. In some embodiments the base stations comprise a separate control apparatus. In other embodiments the control apparatus can be another network element. The control apparatus 109 can be arranged to provide control on communications in the service area of the system. The control apparatus 109 can be configured to provide control functions in association with generation and communication of transmission patterns and other related information and for muting signals by means of the data processing facility in accordance with certain embodiments described below. For this purpose the control apparatus 109 comprises at least one memory 301, at least one data processing unit 302, 303 and an input/output interface 304. Via the interface the control apparatus can be coupled to a receiver and a transmitter of the base station. The control apparatus 109 can be configured to execute an appropriate software code to provide the control functions. It shall be appreciated that similar component can be provided in a control apparatus provided elsewhere in the system for configuring muting patterns and/or controlling coordination of muting the service areas. For example, a central control apparatus 114 can provide at least a part of the coordination functions, as will be described below.

The required data processing apparatus and functions of a base station apparatus, a mobile communication device, a gateway, a central control apparatus and any other appropriate station may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In accordance with an embodiment downlink transmissions in sub-frames on the same frequency carrier from a macro-eNB 107 and an HeNB 118 of FIG. 1 are coordinated. One aspect of LTE-Advanced is that time domain multiplexing (TDM) enhanced inter-cell interference coordination (eICIC) can be applied between network nodes to reduce interference. In some scenarios eICIC can be used for co-channel deployment of macro-eNBs and CSG HeNBs and/or co-channel deployment of macro-eNBs and pico-eNBs. An issue considered relates to networks with co-channel deployment of macro-eNBs/eNBs and closed subscriber group (CSG) HeNBs, while at the same time using time-domain (TDM) enhanced inter-cell interference coordination (eICIC).

An example for a basic scenario setup is illustrated in FIG. 4. More particularly, FIG. 4 depicts use of downlink sub-frames at two network layers. The eNB 107 is active in all sub-frames while the HeNBs are only transmitting in a sub-set 401 of the sub-frames—and the remaining sub-frames 402 are almost blank. In this context, the term “almost blank” is intended to refer to cases where very little or nearly no transmission takes place from the HeNB. Thus the eNB is transmitting as “normal”, and not suffering any performance penalty. This is so since the eNB shall typically ensure full cell coverage, while the CSG HeNB can be installed to introduce local offload. A macro-UEs (not allowed to connect CSG HeNB) close to HeNB 118 can be scheduled during the time-periods with almost blank sub-frames from the HeNBs (i.e. to avoid being exposed to too high interference), while other macro-UE (away from the CSG HeNB) can also be scheduled in other sub-frames. A reason for this is that their interference conditions are not necessarily impacted by the CSG HeNB.

For the TDM eICIC, it can in general be assumed that the macro-eNBs 107 knows in which sub-frames the CSG HeNBs are muted. Also, the macro-eNB can signal, or otherwise indicate, to its users which sub-frames are almost blanked from HeNB-side. In TDM eICIC the macro-eNBs are aware in which sub-frames no data is transmitted by the HeNBs. Similarly macro-eNB can signal or indicate to user equipments enabled to communicate with the macro-eNB within the coverage of the macro-eNB, which sub-frames comprise no data transmitted by the HeNBs. In this way macro-eNB enabled UEs know during which sub-frames to receive data from the macro-eNB.

During the first time period 401 when the data in the sub-frames is normally transmitted on both the macro-eNB layer and the HeNB layer, HeNB enabled user equipment (UE) can be scheduled to receive data in sub-frames from the HeNB layer. Alternatively or additionally some macro-eNB enabled UEs do not experience excessive interference from HeNB and can be scheduled to receive data from the macro-eNB during the sub-frames when the HeNB is not muted.

During the second time period 402 wherein the HeNB 118 is muted during some sub-frames, macro-eNB enabled UEs are scheduled to receive data transmitted from the macro-eNB 107. The macro-eNB enabled UEs may not be allowed to connect to a nearby HeNB 108, for example when the HeNB is configured for communication devices of only a closed subscriber group (CSG). This means that by scheduling the macro-eNB enabled UE to receive data during a sub-frame in which the HeNB is muted, the UEs are not exposed to high interference from the HeNB.

Some embodiments will now be discussed with reference to the flowchart of FIG. 5. In the shown method muting is coordinated in a system comprising radio service areas of a first type, for example the HeNB service areas 115, 117, 119 of FIG. 1 and of a second type, for example the macro cells 100 and 110 of FIG. 1. A node providing a radio service area of the first type can detect a radio service area of the second type based on a first criteria at 10. For example, node 118 can detect the cell 110 provided by base station 107. In accordance with an embodiment the first criteria is satisfied by a radio service area of the second type that is determined to offer the most appropriate radio coverage or where the node is located. For example, the first criteria can be satisfied by a radio service area of the second type determined to have the strongest power.

In accordance with an embodiment the node can also detect if there is at least one second radio service area of the second type that satisfies a second criteria at 12. For example, node 118 of FIG. 1 can detect macro cell 100 in addition to the macro cell 110. The second criteria can be satisfied for example by a radio service area of the second type that is determined to have a power that is within a predefined range from the power of the first radio service area of the second type. In accordance with a more particular example, if the power of the second cell is close enough to the power of the first cell, the criteria is met.

The node can at 14 send information identifying the detected first radio service area. If at least one second radio service area was also detected to satisfy the second criteria, information identifying it as well can also be sent at this stage.

The node can also send information suitable for determining the location of the node. This information can be either the true or estimated location of the node or information that can be used in calculating the location. A control apparatus at the network then receives at 20 the information from the node. The control apparatus can coordinate at 22 muting in the system based on the received information.

In the following more detailed examples for optimal configuration of the pattern of muted sub-frames for HeNBs is considered. The optimal muting pattern can depend on numerous factors. For example, the number of active HeNBs in the macro-cell may need to be taken into account. Many active HeNBs means increased probability of having larger proportion of macro user equipments (macro-UEs) close to HeNBs. This may result in demands for more muted sub-frames, or as an alternative more advanced muting pattern definitions. The relative location of HeNBs inside a macro-cell is a factor that may need to be considered. HeNBs at a macro-cell-edge are typically considered as causing more problems for the macro-UEs since cell-edge macro-UEs typically only receive low signal levels from its serving macro-eNB. Coupling between macro-cells can also be considered, as HeNBs can be placed also at the border between macro-cells, and hence the muting pattern for HeNBs inside neighbouring macro-cells should include some degree of dependency to avoid undesired effects. Also, distribution of macro-UEs inside each macro-cell may be taken in to account. If majority of macro-UEs are located far from the active HeNBs inside the cell, then there may not be any need for muted subframes, and vice versa. It is noted that these are examples only, and other factors may also need to be taken into consideration.

In accordance with an embodiment muting patterns of HeNBs for TDM eICIC are configured based on information from HeNBs of a closed subscriber group (CSG). Each CSG HeNB can utilize network listen mode (NLM) and perform measurement from the co-channel deployed macro-eNBs. The HeNB can identify the co-channel deployed macro-cell to which it assumes the most appropriate, typically to be offering the main coverage. This identification of the macro cell can be based on, for instance, the strongest received power. For example, the highest Reference Signal Received Power (RSRP) can be determined. This determination may also be based on any other appropriate distance indicator, for example path loss to the cell or some other signal, channel or link quality measure. It is noted that a parameters such as the path loss can to certain extend also be reflected in the RSRP measurement. This is so since the RSRP can be presented as the transmitted power scaled by the path loss. A scaling factor that is specific to a given cell can be provided in this context. The identified co-channel deployed macro-cell is then considered to correspond to the macro-cell where the HeNB is located.

Information about the location of the local node can be used in coordinating interference. This can be particularly useful in coordinating inference in systems where local nodes are located in border regions in areas where larger cells overlap. Such information can be provided based on a positioning system, such as the Global System for Positioning (GPS). Local nodes such as the HeNBs 116, 118 and 120 of FIG. 1, however, may not be able to provide accurate location information because information for a position system, such as the GPS, may not be available for them. Also, the local nodes may be deployed without a centralised control. An approximate estimate of the location of the node can nevertheless be provided. Intrinsic information, like results of power and/or quality measurements by the local node, can be utilised to determine an approximate location of the node. The estimated location can be, for example, information that is related to the physical location of the local node or information that is related to the relative position of the local node to a macro base station.

The estimation can be provided at the local node, or alternatively information for use in the estimation can be signalled from the local node. Either the estimate or information on measurements by the local node can be sent to a coordination unit. If the location is estimated by a separate unit based e.g. on the results of power measurements, the estimation unit may also need to know some additional information. For example, a cell ID may need to be provided. The cell ID can then be used to connect a path loss or other quality measurement to a physical transmission location, for example the macro eNB of the cell.

The reporting can be routed via a macro cell, or it can be routed directly to a management system of the local node. For example, in FIG. 1 the HeNBs 118 and 116 can communicate the information directly to the gateway 111. The management system can communicate the information further into a node, for example central control apparatus 114, where the coordination takes place. It is also possible that the local node has no means to exchange information directly between it and a management system. For example, in FIG. 1 there is no X2 connection between HeNB 120 and gateway 111.

If the second strongest received reference signal received power (RSRP) of another co-channel deployed macro cell is within a predefined range, e.g. within X dB, relative to the strongest received macro-cell, the HeNB can be appropriately marked, flagged or otherwise provided with an indication that it is located on the cell border between the two identified macro-cells.

Each CSG HeNB can report the cell identity (ID) of strongest received co-channel macro-cell and the corresponding RSRP or path loss to the cell. It is noted that this is only a possibility for identification of HeNB location in the cell, and that other appropriate mechanisms may also be used. For example, it is possible to have a report containing a full set of measurements of macro information. A central control apparatus can then calculate a more accurate estimation of position of a given CSG HeNB in the system based on the information. If the CSG HeNB is located at the border between two macro-cells, for example according to the criteria outlined above, the HeNB can also report information about the cell ID of the neighbour macro-cell. This can be reported, for example, as a part of information regarding the quality of the channel/link and/or estimated location of the HeNB.

The information is produced so that the interference level induced by CSG HeNBs in the macro cell can be determined. This can relate to the density of the CSG HeNBs in the macro cell. NLM does not only allow to detect macro eNBs but can also be utilised to allow detection and reporting neighbouring CSG HeNBs. From these reports it is possible to determine a parameter such as an average density measure for CSG HeNBs in the macro cell or a CSG HeNB density distribution. It is also possible to combine this information with location information in order to obtain a CSG HeNB density map of the macro cell. Thus, instead of only reporting macro eNBs the neighbouring CSH HeNBs can also be reported. This will provide further information for the configuration of the muting patterns.

The information reported by the HeNBs can be sent to Home eNB gateway (HeNB-GW), HeNB management system, or to a centralized Operations, Administration, and Maintenance (OAM) management system. As mentioned above, there may be a direct link there between, or the information may be routed via the macro cell. Based on this information it can be determined how many CSG HeNBs are active at each macro-cell. Also, the corresponding RSRP/path-loss distribution, as well as the number of CSG HeNBs located at cell boarders can also be determined.

A weighted sum of the number of CSG HeNBs and their RSRP/path-loss can then be calculated per macro-cell. This is denoted as Q_n, for macro-cell #n in the following example. Given Qn, the number of required muted sub-frames (e.g. per radio frame) for the CSG HeNBs inside macro-cell #n can be determined as M_n=f(Q_n). f( ) can be an increasing function, that is the more HeNBs there are inside a macro-cell, the more muted sub-frames are configured. An option to provide the function is to define f(x) as and linear function, for example of the format A*x+B, where A and B are configuration parameters.

It is noted that the above gives only examples, and that the exact description of the function, f( ), and/or the criteria and considerations can be implementation specific. It is not even necessary to employ a function. For example, the association between the HeNBs and their characteristics and the number of muted subframes can be defined by means of a predefined or dynamic table.

The herein described interference coordination arrangement allows control of interference levels in a macro cell. An acceptable interference level can depend on the requested data throughput in the macro cell. For example, data throughput may be low in the evenings or in the night time. On the other hand, data throughput in the CSG HeNBs may be higher in the evenings when for example streaming applications are served in home cells. A factor can be used that accounts for the different data traffics in macro cells. In order to capture the effect of minimum data rate requirement for macro-Ues, this factor can be introduced into the function f( ) such that function f( ) also includes a minimum data rate requirement constraint.

Parameter Q_n for reference signal received power (RSRP) can be taken as a measure of the interference in the home cells induced by neighbouring macro eNBs. Thus is can be considered as an estimate for the total transmit power of all CSG HeNBs in the macro cell since the transmitted signal from each CSG HeNBs should be at least as strong as the received signals from the macro eNBs. Weighting with the HeNB path-loss can be provided to mitigate problems caused by HeNBs close to Macro-eNB. This is mainly so because the macro-eNB is still dominating even in such locations. For HeNBs further away from the macro-eNBs, macro-Ues are likely to experience more interference from a non-allowed CSG cell, and therefore may require more sub-frames to be muted. Given the number of CSG HeNBs inside each macro-cell (denoted K), as well as the number of those with neighbour relationships (denoted R), the following ratio can be calculated for each cell: H=R/K. If the ratio H is a low, below a threshold, the configuration of muted sub-frames for all the CSG HeNBs inside the cell can be configured without further coordination. If the ratio H is a high/exceeding a threshold, this indicates that a substantial number of HeNBs inside a macro-cell is located close to neighbouring macro-cells. This implies that when configuring the M_n muted sub-frames for the CSG HeNBs inside macro cell #n, the muting shall be aligned as well as possible with the muting pattern(s) of the neighbouring macro-cells. For an optimum result, the muting patterns can be configured to have as much overlap as possible.

It can be assumed that a network is synchronized. Synchronization can be provided on multiple levels. For instance, it can be assumed that subframes start at the same time, meaning that e.g. OFDM symbol #0 of any subframe starts roughly at the same time everywhere. Counting of the subframe numbers and frame numbers can be offset between base stations, for example between the (H)eNBs. This means that with subframe shift of 3 subframes, we will have the macro eNB transmitting subframe 3, while HeNB transmits subframe 0. Time-wise shifted muting patterns can thus be introduced between CSG HeNBs. This can be used to avoid or at lest mitigate any clustering in scheduling of macro user equipments to only a few subframes. By the shifting a muting pattern can be maintained for all HeNBs under a macro-cell area. In case the muting patterns are time-wise distributed, the system level impact can be reduced. Shifting can be used to allow transmission of common channels—even for CSG eNBs.

The centralized control unit can signal to the relevant HeNBs in the network instructions regarding the sub-frames they shall mute. Standardized procedures can be provided for reporting information to/from CSG HeNBs and the centralized unit, for example an OAM server. An algorithm can be provided at the centralized unit for processing the information and calculating the muting pattern for the CSG HeNBs. The algorithm for processing the received information and for determining a muting pattern to be used by the HeNBs inside each macro-cell. Reporting of the measurements/information can take place from each HeNB to the centralized control unit. The muting pattern can be signalled to all HeNBs in the network. Indication of muting patterns can be sent to eNBs ‘hosting’ a set of CSG HeNBs. This information can be used in scheduling.

Muting information can also be communicated to macro user equipments. The user equipment may use information on the muting patterns when providing measurements. For example, muting information can be taken into account by user equipment measuring reference signal received power and/or reference signal received quality (RSRP/RSRQ) of other cells as a part of handover measurements. By informing user equipments of muting patterns they can be made aware of muted subframes and that measurements in these subframes may not give an optimal result, as the measurements would not reflect correctly the conditions.

In accordance with an embodiment appropriate muting pattern or patterns are selected from a set of patterns. The set of patterns can be a set of few possible options for muting patterns, each pattern having different number of muted subframes. A control apparatus determining an appropriate pattern can collect data needed for the selection and to estimate an approximate needed muting pattern based thereon. For example, the control apparatus can then select, based on estimated required number of muted sub-frames, e.g. the M_n parameter of the above example, a predefined muting pattern that comes closest to this value. A given strategy for connectivity of macro user equipment can be taken into account in combination with an estimated muting pattern a muting pattern when selecting a pattern that is considered as most appropriate from the possible set. The control apparatus for the selection can be provided in a central controlling node, for example a OAM server, a gateway or a macro eNBs. Instead of receiving a pattern from an external source, predefined rules for muting pattern configuration may also be provided in and used by the local nodes, for example in CSH HeNBs.

In case of a MIMO enabled transmission arrangement, some measurements can rely on observing measurements from multiple transmit antennas. The information from the measurements of the multiple antennas can be provided for calculating the RSRP and related information.

It is noted that whilst embodiments have been described in relation to LTE-Advanced, similar principles can be applied to any other communication system where a carrier comprising a multiple of component carriers is employed. Also, instead of carriers provided by a base station a carrier comprising component carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For example, a combination of one or more of any of the other embodiments previously discussed can be provided. All such and similar modifications of the teachings of this invention will still fall within the scope of this invention as defined in the appended claims.

1-47. (canceled)

48. A method for coordinating muting in a system comprising radio service areas of a first type and of a second type, the method comprising:
detecting, by a node providing a radio service area of the first type, a first radio service area of the second type based on a first criteria;
determining information suitable for determining the location of the node; and
communicating information for identifying the first radio service area and said information suitable for determining the location of the node.

49. A method according to claim 48, comprising
detecting at least one second radio service area of the second type based on a second criteria; and
communicating information for identifying the at least one second radio service area of the second type.

50. A method for controlling muting in a system comprising radio service areas of a first type and of a second type, the method comprising:
receiving from a node providing a radio service area of the first type information for identifying a first radio service area of the second type;
receiving information suitable for determining the location of the node; and
coordinating muting based on the received information.

51. A method in according to claim 50, comprising receiving information for identifying at least one second radio service area of the second type, wherein the first radio service area of the second type satisfies a first criteria and the at least one second radio service area of the second type satisfies a second criteria.

52. A method according to claim 48, wherein the first criteria is satisfied by a radio service area of the second type determined to offer the most appropriate radio coverage or where the node is located.

53. A method according to claim 52, wherein the first criteria is satisfied by a radio service area of the second type determined to have the strongest power.

54. A method according to claim 48, wherein the second criteria is satisfied by a radio service area of the second type determined to have a power that is within a predefined range from the power of the first radio service area of the second type.

55. An apparatus for use in coordinating muting in a system comprising radio service areas of a first type and of a second type, the apparatus comprising at least one processor, and at least one memory including computer program code, wherein the at least one memory and the computer program code are configured, with the at least one processor, to
detect a first radio service area of the second type based on a first criteria at a node providing a radio service area of the first type;
determine information suitable for determining the location of the node; and
cause communication of information for identifying the first radio service area and said information suitable for determining the location of the node.

56. An apparatus according to claim 55, configured to detect at least one second radio service area of the second type based on a second criteria, and to cause communication of information identifying the at least one second radio service area of the second type.

57. An apparatus for controlling muting in a system comprising radio service areas of a first type and of a second type, the apparatus comprising at least one processor, and at least one memory including computer program code, wherein the at least one memory and the computer program code are configured, with the at least one processor, to
process information for identifying a first radio service area of the second type, the information being received from a node providing a radio service area of the first type;
process information suitable for determining the location of the node; and
coordinate muting based on the information.

58. An apparatus according to claim 57, configured to receive information for identifying at least one second radio service area of the second type, wherein the first radio service area of the second type satisfies a first criteria and the at least one second radio service area of the second type satisfies a second criteria.

59. An apparatus according to claim 55, wherein the first radio service area of the second type has the strongest power.

60. An apparatus according to claim 59, wherein the power of the second radio service area of the second type is within a predefined range from the power of the first radio service area of the second type.

61. An apparatus according to claim 55, configured to assign the node with an indication of closeness to a border between the first and the at least one second radio service areas of the second type.

62. A computer program comprising code means adapted to perform the steps of claim 48 when the program is run on a processor.
